(19) United States
(12) Patent Application Publication
(10) Pub. No.: US 2005/0064128 A1
(43) Pub. Date: Mar. 24, 2005

(54) Method and apparatus for forming building panels and components which simulate man-made tiles and natural stones

(76) Inventors: John Clinton Lane, Nashville, TN (US); George Christopher Lane, Alpharetta, GA (US); Jorge Del Valle, Alburn, AL (US)

Correspondence Address: WITHERS & KEYS, LLC, P. O. BOX 2049, MCDONOUGH, GA, 30253, US

(21) Appl. No.: 10/875,044

(22) Filed: Jun. 23, 2004

Related U.S. Application Data
(60) Provisional application No. 60/480,898, filed on Jun. 24, 2003.

(51) Int. Cl. B32B 3/10

(52) U.S. Cl. 428/44

(57) ABSTRACT

Modular building panel systems, building column structures and other building components are disclosed. Methods of making and using modular building panel systems, building column structures and other building components are also disclosed.

### CROSS-REFERENCE TO RELATED APPLICATIONS

This patent application claims the benefit of priority to U.S. provisional patent application Ser. No. 60/480,898 entitled “A METHOD AND APPARATUS FOR FORMING BUILDING PANELS AND COMPONENTS WHICH SIMULATE VARIOUS MAN-MADE TILES AND NATURAL STONES” filed on Jun. 24, 2003, the subject matter of which is incorporated herein in its entirety.

### FIELD OF THE INVENTION

The present invention relates to modular building panel systems, building column structures and other building components. The present invention further relates to methods of making and using modular building panel systems, building column structures and other building components.

### BACKGROUND OF THE INVENTION

Building panels and column structures have conventionally been constructed by placing man-made tiles, artificial stones, natural stones and other decorative objects on an inorganic substrate with an adhesive such as cement mortar or glue. Further, building column structures and fence sections have been made of many materials such as wood, metal, plastic, concrete, man-made tiles and stone, and natural stones. Wood is subject to rot, combust, insect attack, and requires maintenance. Metal is subject to corrosion, requires maintenance, and is heavy in weight. Concrete, whether solid or hollow, is very heavy, expensive, and subject to frost-thaw cycle. Natural stones are expensive, heavy and labor intensive, requiring experience and skill to install. Man-made tiles and stones are expensive, labor intensive and require skill to install.

In view of the shortcomings of the above-described conventional building materials, there exists a need in the art for building panel and various components that provide one or more of the following advantages over conventional building materials:
(1) building materials that are lightweight relative to conventional building materials;
(2) building materials that are more easily handled relative to conventional building materials;
(3) building materials that are will not rot or decay;
(4) building materials that cost less than conventional building materials;
(5) building materials that do not require specialized skills or experience to install;
(6) building materials that do not require expensive tools to install;
(7) building materials that can be easily moved, removed or replaced;
(8) building materials that do not freeze-thaw like conventional materials; and
(9) building materials that do not require a mason or general contractor to install.

### SUMMARY OF THE INVENTION

The present invention addresses some of the difficulties and problems discussed above by the discovery of new building material products. The building products include, but are not limited to, building panels, structural columns having a base profile, a column portion, and a capital component on top of the column portion. The building products of the present invention provide one or more of the following advantages over known building materials: (1) the building materials are lightweight relative to conventional building materials; (2) the building materials are more easily handled relative to conventional building materials; (3) the building materials are more resistant to rot or decay; (4) the building materials are not as expensive as conventional building materials; (5) the building materials do not require specialized skills or experience to install; (6) the building materials do not require expensive tools to install; (7) the building materials can be easily moved, removed or replaced; (8) the building materials do not freeze-thaw like conventional materials; and (9) the building materials do not require a mason or general contractor to install.

In one exemplary embodiment, the building material product comprises a building panel, wherein the building panel comprises (a) a foam core having a first outer surface and a second outer surface, (b) a first coating on the first outer surface of the foam core, wherein the first coating has an outer surface profile comprising (i) multiple areas, each of which has an appearance, size and shape resembling a man-made tile, a man-made brick or a natural stone, and (ii) a grid of grout lines surrounding at least a portion of each of the multiple areas, and (c) a second coating on the second outer surface of the foam core, wherein the second coating has a substantially flat surface profile.

In a further exemplary embodiment, the building material product comprises a building panel, wherein the building panel comprises (a) a polyurethane foam core having a first outer surface and a second outer surface, (b) a first coating layer of aliphatic polyurethane on the first outer surface of the foam core, wherein the first coating has an outer surface profile comprising (i) multiple areas, each of which has an appearance, size and shape resembling a man-made tile, a man-made brick or a natural stone, and (ii) a grid of grout lines surrounding at least a portion of each of the multiple areas, and (c) a second coating layer of aromatic polyurethane on the second outer surface of the foam core, wherein the second coating has a substantially flat surface profile.

One or more of the above-described building panels may be combined and/or joined to one another to form other building structures. In addition, other building components of the present invention, such as a base profile and a capital component, may be combined with the one or more building panels to form various structures. Various structures include, but are not limited to, a wall surface structure, a column, a mailbox, a chimney or fireplace structure, outdoor furniture or decorative structures, and other structures.

The present invention is even further directed to methods of making and using building products. In one exemplary method of making a building panel, the method comprises the steps of (a) placing an insert into a mold, wherein the insert has an outer surface profile comprising (i) multiple areas, each of which has an appearance, size and shape resembling a man-made tile, a man-made brick or a natural stone, and (ii) a grid of grout ridges surrounding at least a portion of each of the multiple areas, (b) applying a first coating onto the insert, (c) applying a second coating onto a mold lid, wherein the mold lid has a size and shape so as to fit onto an upper periphery of the mold, forming an enclosed volume within the mold, (d) fixing the mold lid onto the mold, (e) injecting a foamable core material into the enclosed volume within the mold, and (f) curing the first coating, the second coating and the foamable core material to form a building panel having an exterior surface profile that is a mirror image of the outer surface profile of the insert.

In a further exemplary method of the present invention, the method comprises one or more of the above-described method steps, and further includes attaching one or more building panels to an upper surface of a base profile, and attaching a capital component onto an upper surface of the one or more building panels. The resulting structure is suitable for use as a column.

These and other features and advantages of the present invention will become apparent after a review of the following detailed description of the disclosed embodiments and the appended claims.

### BRIEF DESCRIPTION OF THE FIGURES

FIG. 1A depicts a frontal view of an exemplary finished manufactured building panel with the appearance of natural stacked stones illustrating exemplary cutting lines: six horizontal cutting lines and sixteen vertical cutting lines;

FIG. 1B depicts a detailed view of the left lower corner of the exemplary finished manufactured building panel of FIG. 1A;

FIG. 2 depicts a cross-sectional view of an exemplary finished panel of the present invention illustrating the outer exterior texture coating, the structural foam inner core, and the interior flat non-textured coating;

FIGS. 3A-D depict four exemplary panels of the present invention that may be joined to one another to form a larger panel;

FIGS. 3E-F depict an exploded view of two of the four exemplary panels shown in FIGS. 3A-D, wherein the panels further comprise matching locking mechanisms;

FIG. 4 depicts a perspective view of an exemplary finished corner panel of the present invention suitable for forming two sides of a column structure;

FIG. 5 depicts a perspective view of an exemplary finished structural base profile of the present invention;

FIG. 6 depicts a perspective view of an exemplary finished structural capital profile of the present invention;

FIG. 7 depicts a perspective view of an exemplary mold box with a rubber form liner used to form an exemplary modular building panel of the present invention;

FIG. 8 depicts a perspective view of the exemplary mold box of FIG. 7 with a different rubber form liner inserted into the mold box;

FIG. 9 depicts a perspective view of an exemplary apparatus for forming an outside corner keyed component panel of the present invention;

FIG. 10 depicts a perspective view of an exemplary apparatus for forming an inside corner keyed component panel of the present invention;

FIG. 12 depicts a perspective view of an exemplary apparatus for forming an exemplary structural base profile of the present invention;

FIG. 13 depicts an exploded view of an exemplary apparatus for forming an exemplary structural base profile of the present invention;

FIG. 14 depicts a perspective view of an exemplary apparatus for forming an exemplary capital of the present invention;

FIG. 15 depicts a cross-sectional view of two exemplary finished panels of the present invention prior to joining to one another;

FIG. 16 depicts a cross-sectional view of the two exemplary finished panels of FIG. 15 with matching router channels therein; and

FIG. 17 depicts a cross-sectional view of the two exemplary finished panels of FIG. 16 joined to one another.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

The present invention is directed to building products that may be used to replace man-made tile, man-made brick, or natural stone. The building products may comprise a number of separate components that are attached to one another to form various structures including, but not limited to, a wall surface structure, a column, a mailbox, as well as many others structures. The present invention is further directed to methods of making building products that resemble man-made tile, man-made brick, or natural stone, but have one or more advantages over man-made tile, man-made brick, or natural stone. The present invention is even further directed to methods of using building products to produce structures previously prepared using man-made tile, man-made brick, or natural stone.

I. Building Products

The present invention is directed to building products and methods of making and using the building products. A description of exemplary building products is given below.

A. Building Panels

One exemplary building product of the present invention comprises a building panel. The building panels of the present invention may comprise a variety of configurations and use a variety of materials. Exemplary building panels of the present invention are described below.

1. Building Panel Construction

In one exemplary embodiment, the building panel comprises (a) a foam core having a first outer surface and a second outer surface, (b) a first coating on the first outer surface of the foam core, wherein the first coating has an outer surface profile comprising (i) multiple areas, each of which has an appearance, size and shape resembling a man-made tile, a man-made brick or a natural stone, and (ii) a grid of grout lines surrounding at least a portion of each of the multiple areas, and (c) a second coating on the second outer surface of the foam core, wherein the second coating has a substantially flat surface profile.

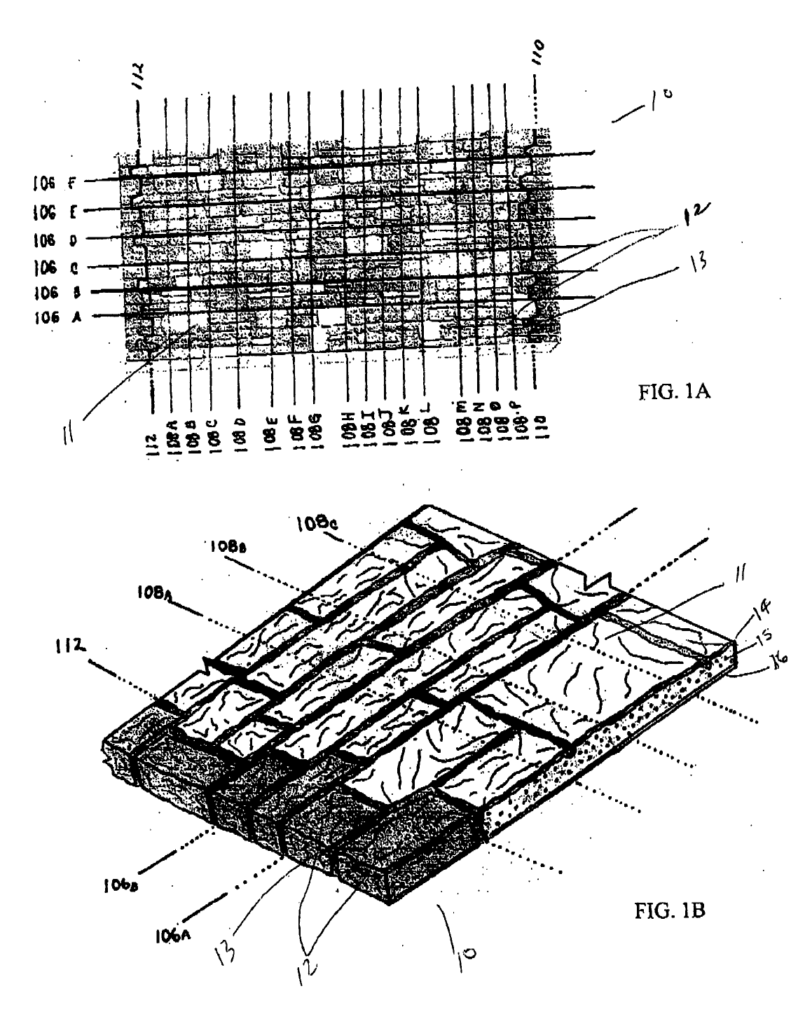

An exemplary building panel of the present invention is shown in FIGS. 1A-1B. As shown in FIGS. 1A-1B, exemplary building panel 10 has an exterior surface 11 that has the appearance of multiple areas 12 that resemble natural stacked stones separated by grout lines 13. In this exemplary embodiment, multiple areas 12 resembling stones have a variety of sizes and shapes. In other alternative embodiments, multiple areas 12 may resemble man-made tiles or man-made bricks, wherein each of the multiple areas has substantially the same appearance, size and shape.

Exemplary building panel 10 may be cut into smaller panel pieces by cutting along one or more cut lines. As shown in FIGS. 1A-1B, exemplary building panel 10 may be cut along any of exemplary horizontal cutting lines 106A-106F and/or vertical cutting lines 108A-108P. For example, exemplary building panel 10 can be cut along any of exemplary horizontal cutting lines 106A-106F to form smaller horizontal building panels suitable for use in siding applications. Such horizontal building panels can, for example, have a width of 12″, 16″, 24″, 32″, 36″ or 42″ by cutting along exemplary horizontal cutting lines 106A-106F, and a length of up to about 12 feet or greater, typically from about 4 to about 8 feet.

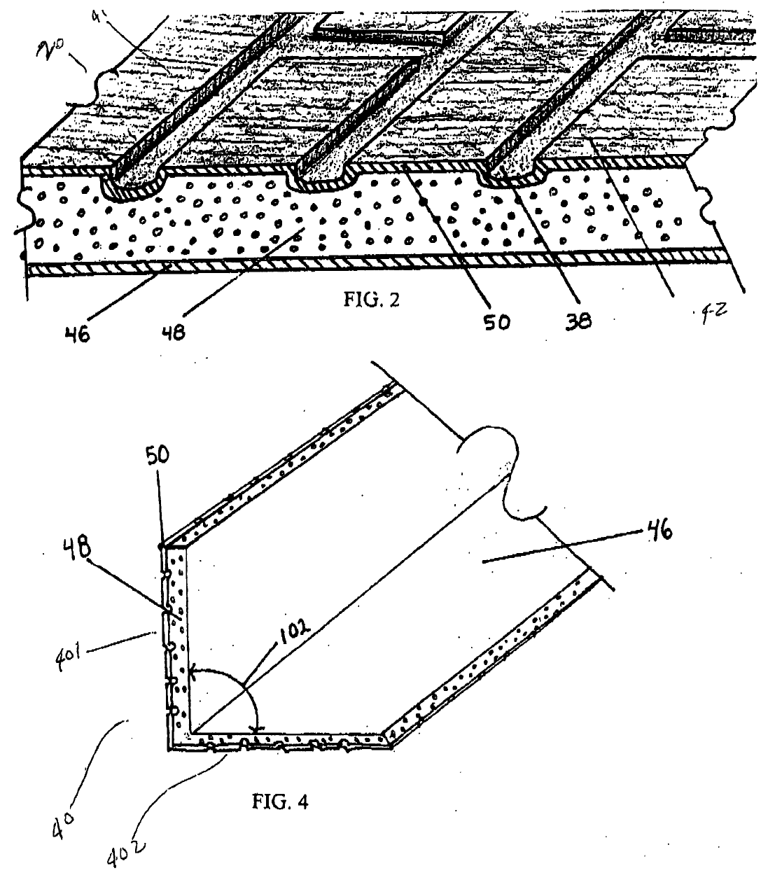

FIG. 1B depicts a detailed view of a left lower corner of exemplary building panel 10 shown in FIG. 1A. FIG. 1B also provides a cross-sectional view of the layers typically used to form exemplary building panel 10. As shown in FIG. 1B, exemplary building panels of the present invention typically comprise three distinct layers: outer exterior texture coating 14, structural foam inner core 15, and interior flat non-textured coating 16. A more detailed cross-sectional view of exemplary building panels of the present invention is shown in FIG. 2.

Exemplary building panel 20 shown in FIG. 2 comprises exterior textured coating layer 50, structural foam inner core layer 48, and interior flat non-textured coating layer 46. In this embodiment, exemplary building panel 20 has an exterior surface 41 that has the appearance of multiple areas 42 that resemble man-made tiles or bricks separated by grout lines 38. In this exemplary embodiment, multiple areas 42 resembling man-made tiles or bricks have substantially the same appearance, size and shape.

Exemplary building panel 20 typically has an average overall thickness of up to about 38 mm (1.5 inch), wherein the average overall thickness is measured from a first side of interior flat non-textured coating layer 46 to the upper surface of multiple areas 42. The average overall thickness may vary depending on a number of factors including, but not limited to, the particular application for the building panel, the materials used, the design of the multiple areas 42 and grout lines 38, and the overall dimensions of the panel (i.e., typically, the larger the dimensions of the panel, the thicker the panel). In some cases, the overall thickness of the building panel of the present invention may be greater than 38 mm (1.5 inch), and in other cases, may be less than 38 mm (1.5 inch). Typically, the distance from an upper surface of grout lines 38 to an upper surface of multiple areas 42 ranges from about 5.0 mm (200 mil) to about 12.7 mm (500 mil), and is desirably about 9.5 mm (375 mil).

Exterior textured coating layer 50 may comprise a single layer or multiple layers adjacent to one another. In either case, exterior textured coating layer 50 has an average overall thickness (i.e., the overall thickness of a single layer or combined multiple layers) that varies depending on a number of factors including, but not limited to, the particular application for the building panel, the materials used, and the design of the multiple areas 42 and grout lines 38. Typically, exterior textured coating layer 50 has an average overall thickness of up to about 2.5 mm (100 mil), desirably, from about 0.1 mm (5 mil) to about 1.9 mm (75 mil), more desirably, about 1.4 mm (55 mil).

Interior flat non-textured coating 16 may also comprise a single layer or multiple layers adjacent to one another. In either case, interior flat non-textured coating 16 typically has an average overall thickness (i.e., the overall thickness of a single layer or combined multiple layers) that varies depending on a number of factors including, but not limited to, the particular application for the building panel, and the materials used. Typically, interior flat non-textured coating 16 has an average overall thickness of up to about 2.5 mm (100 mil), desirably, from about 0.6 mm (25 mil) to about 1.9 mm (75 mil), more desirably, about 1.3 mm (50 mil).

Structural foam inner core layer 48 may further comprise a single layer or multiple layers adjacent to one another. In either case, structural foam inner core layer 48 typically has an average overall thickness (i.e., the overall thickness of a single layer or combined multiple layers) that varies depending on a number of factors including, but not limited to, the particular application for the building panel, and the materials used. Typically, structural foam inner core layer 48 has an average overall thickness of up to about 25 mm (1000 mil), desirably, from about 6.4 mm (250 mil) to about 19.0 mm (750 mil), more desirably, about 12.7 mm (500 mil).

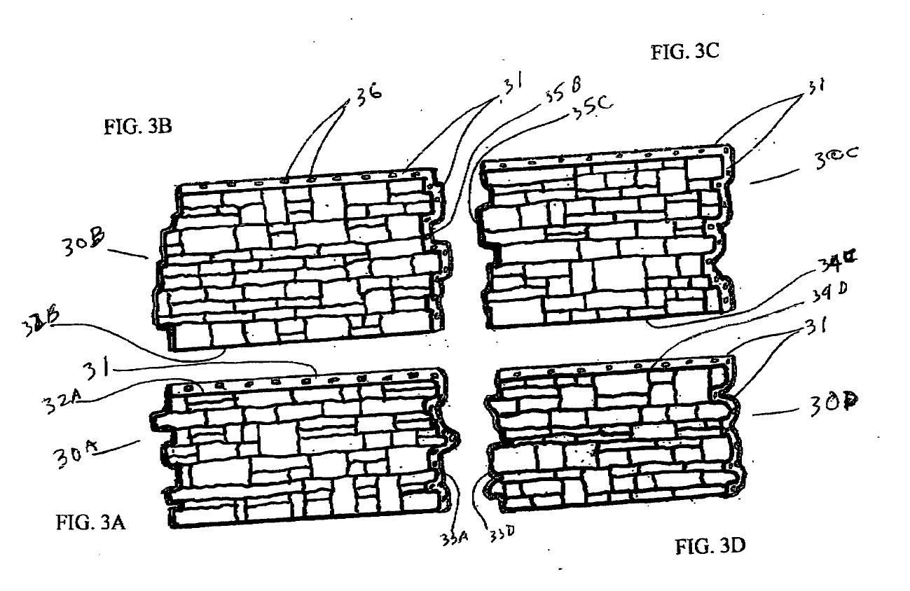

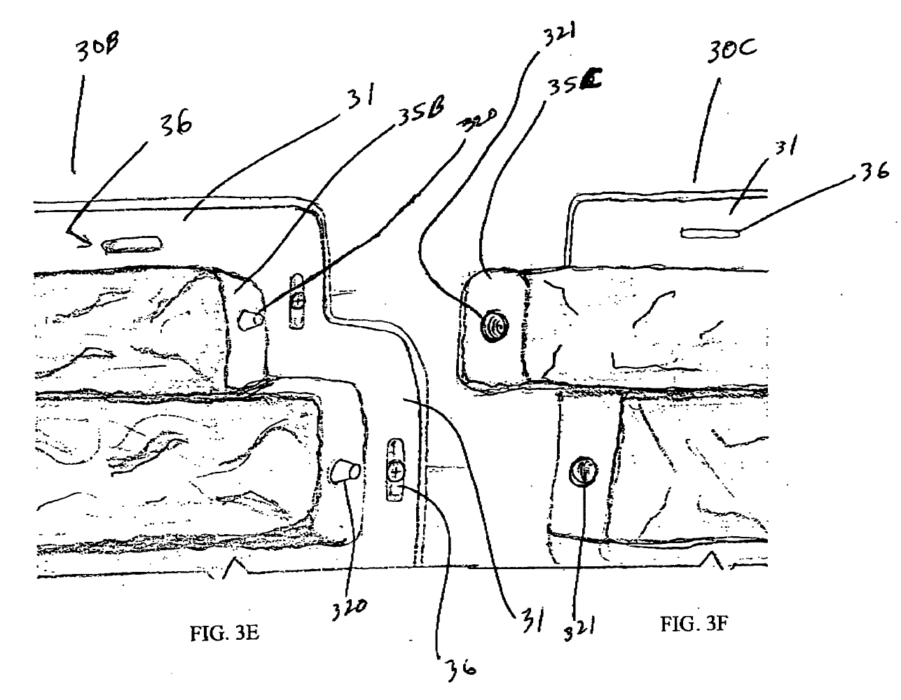

One or more of the above-described building panels of the present invention may be combined and/or joined to one another to form a variety of products. In one embodiment, two or more building panels are combined with one another to form a wall surface. The resulting group of panels interlocks with one another to form a continuous running pattern. Such an embodiment of the present invention is shown in FIGS. 3A-3D.

FIGS. 3A-3D depict four exemplary building panels 30A-30D that may be joined to one another to form a larger panel. Each of exemplary building panels 30A-30D have edge 31 extending along two of the four sides of each panel. It should be understood that edge 31 can extend along one or more sides of a given panel. Further, each of exemplary building panels 30A-30D have holes 36 within edge 31 so that exemplary building panels 30A-30D may be attached to a surface such as, for example, wallboard, foamboard, wood, concrete, metal, or a combination thereof.

In this particular embodiment, exemplary building panels 30A-30D may be positioned relative to one another to form a larger panel such that the seams between adjacent individual panels are substantially undetectable. As shown in FIGS. 3A-3D, the following pairs of edges of exemplary building panels 30A-30D may be positioned adjacent to one another to form a larger wall structure: edge pair 32A and 32B, edge pair 33A and 33D, edge pair 34C and 34D, and edge pair 35B and 35C.

In order to enhance the interlocking property of exemplary building panels 30A-30D, corresponding interlocking mechanisms (such as those shown in FIGS. 3E-F) may be positioned within joining surfaces of adjacent panels. Corresponding interlocking mechanisms may include, but are not limited to, a locking key having a desired first cross-sectional shape and a matching indentation having a second cross-sectional shape that is the mirror image of the first cross-sectional shape. For example, a locking key having a circular first cross-sectional shape, a diameter of about 0.25 inch, and a length of about 0.5 inch may be positioned in panel 30B and extending in a direction toward panel 30C and outward from edge 35B, while a corresponding indentation having a circular second cross-sectional shape, a diameter of about 0.25 inch, and a depth of about 0.5 inch may be positioned within panel 30C extending a depth into edge 35C. One or more similar corresponding locking mechanisms may be used along any of the following edge pairs: edge pair 32A and 32B, edge pair 33A and 33D, and edge pair 34C and 34D as shown in FIGS. 3A-D.

Exemplary corresponding interlocking mechanisms are shown in FIGS. 3E-F. As shown in FIGS. 3E-F, locking keys 320 having a desired first cross-sectional shape (e.g., a circular cross-sectional shape and a truncated cone configuration) and matching indentations 321 may be used to further enhance the interlocking property of exemplary building panels 30A-30B. Typically, locking keys 320 are an integral part of the foam core layer used to form panel 30B, while matching indentations 321 are an integral part of the foam core layer used to form panel 30C. Locking keys 320 and matching indentations 321 may be formed during formation of the foam core layer of a building panel as described below. It should be noted that the locking keys and corresponding indentations may have any desired cross-sectional configurations and dimensions as long as the pair of corresponding interlocking mechanisms assists in the interlocking properties of adjacent panels.

In a further embodiment of the present invention, one or more building panels of the present invention may be attached to one another to form a building panel having an angle between the adjacent panels. The angle between the adjacent panels may be an angle between 0 and 180 degrees. Typically, the angle between the adjacent panels is 30°, 45°, 90°, or 135°. One such building structure is shown in FIG. 4.

As shown in FIG. 4, exemplary finished corner panel 40 of the present invention comprises adjacent panels 401 and 402 attached to one another to form an angle 102 between the panels. In this particular example, angle 102 is a 90° angle. Further, in this embodiment, exterior textured coating layers 50 of adjacent panels 401 and 402 face outward, while interior flat non-textured coating layers 46 face inward. Such a structure is referred to herein as an “outside corner panel” and is suitable for forming two sides of a column structure.

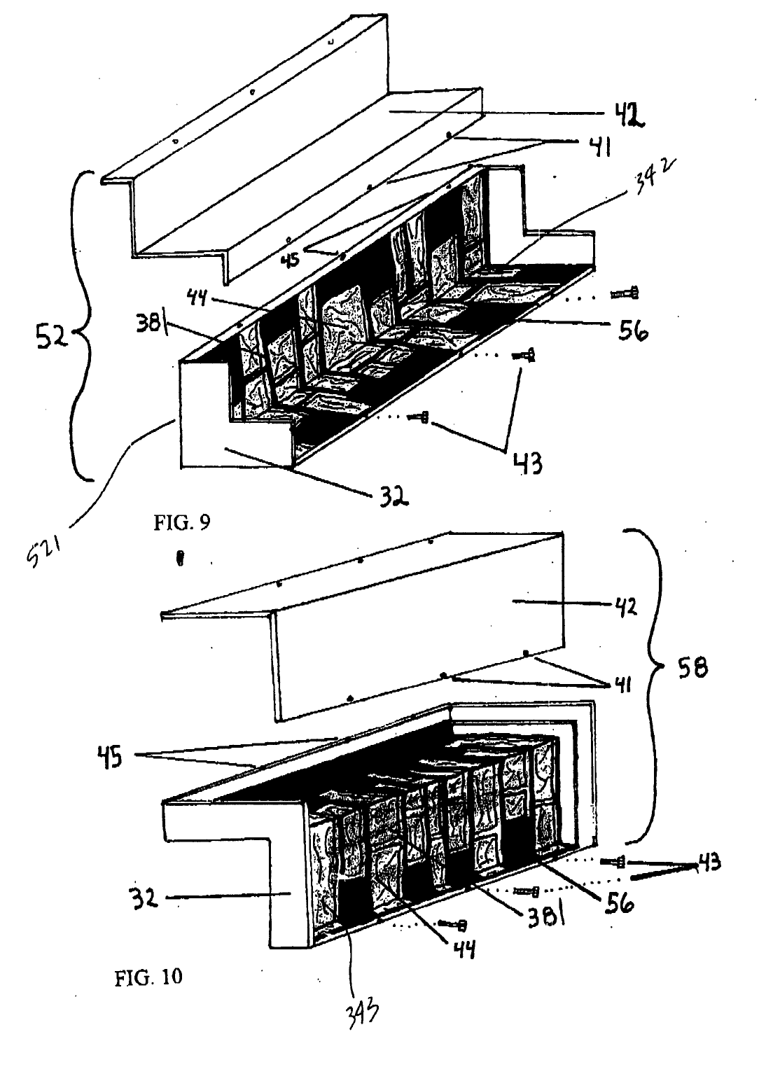

In an alternative embodiment of the present invention, a seamless, one-piece inside corner panel or outside corner panel (similar to the panel as shown in FIG. 4) may be prepared (see, FIGS. 9-10 and accompanying description below). The seamless panel may have an angle between adjacent sections of the corner panel, such as described above. In one desired embodiment, the seamless, one-piece inside corner panel or outside corner panel has a 90° angle between adjacent panel sections. Such a structure is also particularly suitable for forming two sides of a column structure.

2. Building Panel Materials

The building panels of the present invention may be formed from a variety of materials. Suitable materials include, but are not limited to, materials described below.

a. Exterior Textured Surface Materials

Exterior textured coating layers used to form building panels of the present invention may comprise a variety of materials. Suitable materials include, but are not limited to, one or more polymeric materials, one or more colorants, and one or more additives (e.g., UV stabilizers, insecticides, etc.). Suitable polymeric materials include, but are not limited to, polyurethanes, polyureas, and combinations thereof. The exterior textured coating layer may comprise numerous layer portions, each of which is combined with one another to form the outermost portions of the exterior textured coating layer, and each of which comprises one or more of the above-mentioned materials.

In one exemplary embodiment of the present invention, the exterior textured coating layer comprises at least one layer, wherein the at least one layer (i) comprise one or more layer portions, and (ii) contains an aliphatic polyurethane in an amount of up to about 100 parts by weight (pbw), based on a total weight of the exterior textured coating layer. Suitable aliphatic polyurethanes include, but are not limited to, aliphatic polyurethanes formed from (i) one or more aliphatic isocyanates, such as hexamethylene diisocyanate (HDI) and isophorone diisocyanate (IPDI), and (ii) one or more polyesters and/or polyols.

In a further exemplary embodiment of the present invention, the exterior textured coating layer comprises two or more layers including at least one decorative layer and a support layer. In this embodiment, the at least one decorative layer comprises at least one layer, wherein the at least one layer (i) comprise one or more layer portions, and (ii) contains an aliphatic polyurethane in an amount of up to about 100 pbw, based on a total weight of the exterior textured coating layer, and the support layer (between the at least one decorative layer and a foam core) contains an aromatic polyurethane in an amount of up to about 100 pbw, based on a total weight of the support layer. Suitable aromatic polyurethanes include, but are not limited to, aromatic polyurethanes formed from (i) one or more aromatic isocyanates, such as diphenylmethane-4-4′-diisocyanate (MDI) and toluene diisocyanate (TDI), and (ii) one or more polyesters and/or polyols, such as a polyether polyol.

Commercially available aliphatic polyurethanes that may be used in the present invention include, but are not limited to, aliphatic polyurethanes commercially available from Pacific Polymers International, Inc. (Garden Grove, Calif.) under the trade designation ELASTO-GLAZE, such as ELASTO-GLAZE 6001 AL, a liquid applied, single-component, moisture-curable aliphatic polyurethane; aliphatic polyurethanes commercially available from Madison Chemical Industries, Inc. (Milton, Ontario CANADA) under the trade designations ACRYLATHANE, such as ACRYLATHANE 55, ACRYLATHANE 85, and ACRYLATHANE 5200, and TUFSHEEN, such as TUFSHEEN II; and INSTAGEL™, such as INSTAGEL™ 20, 40 and 50; and aliphatic polyurethane containing systems commercially available from Industrial Polymers Incorporated (Houston, Tex.) under the trade designations SPRAYGEL™, such as SPRAYGEL™40; and URAGEL™, such as URAGEL™ 751, 760, 770, 775, 780, 785, 790 and 795. Commercially available polyureas that may be used in the present invention include, but are not limited to, polyureas commercially available from Pacific Polymers International, Inc. (Garden Grove, Calif.) under the trade designations PACPOLYUREA; ELASTO THANE, such as ELASTO THANE 920; and ELASTO DECK, such as ELASTO DECK 9900.

Commercially available aromatic polyurethanes that may be used in the present invention include, but are not limited to, aromatic polyurethanes commercially available from Madison Chemical Industries, Inc. (Milton, Ontario CANADA) under the trade designation CORROCOTE, such as CORROCOTE II PW, CORROCOTE II Ultraliner, CORROCOTE II Classic, CORROCOTE II PhenoLiner, CORROCOTE PLUS, CORROCOTE II HydroThane, CORROCOTE ‘S’, and CORROCOTE ‘M’.

The exterior textured coating layer(s) may further comprise one or more colorants. Colorants may be used to color at least the outermost surface of the exterior textured coating layer in order to provide the appearance of (i) multiple areas resembling man-made tile, man-made brick or natural stone in one or more colors, and (ii) grout lines resembling grout or cement between the multiple areas in a similar or different color than the multiple areas. When present, the one or more colorants typically comprise up to about 5.0 parts by weight (pbw), more typically, about 0.5 to about 1.5 pbw, based on a total weight of the exterior textured coating layer.

The above-described aliphatic polyurethanes commercially available from Pacific Polymers International, Inc. (Garden Grove, Calif.) under the trade designation ELASTO-GLAZE are available in over forty-two (42) different colors. However, other colorants may be added to a given aliphatic polyurethane in order to obtain a desired color. Commercially available colorants that may be used in the present invention include, but are not limited to, colorants commercially available from BroCom Corporation (Colorado Springs, Colo.), wherein each colorant contains one or more of the following colorant components: titanium dioxide, calcium carbonate, iron oxide (CAS No. 1332-37-2), ferrite material (CAS No. 68187-51-9), iron oxide (CAS No. 1317-61-9), Fe₂O₃H₂O (CAS No. 51274-00-1), ultramarine blue (CAS No. 57455-37-5), Phthalocyanine Blue, carbon black, Pigment Yellow 138, Red Lake “C” (CAS No. 5160-02-1), Pigment Scarlet (CAS No. 1325-16-2), Lithol Scarlet (CAS No. 7023-61-2), Phthalocyanine Green (CAS No. 1328-53-6), metallic soap (CAS No. 557-05-1), hydrated alumina (CAS No. 21645-51-2), silicon dioxide (CAS No. 112945-52-5), and ester salt (CAS No. 000577-11-7).

The exterior textured coating layer(s) may further comprise one or more other additives. Other suitable additives include, but are not limited to, UV stabilizers, insecticides, or combinations thereof. When present, each of the one or more filler materials typically comprises up to about 5.0 pbw, more typically, about 0.5 to about 1.5 pbw, based on a total weight of the exterior textured coating layer.

Any of the above-described polymers for forming the exterior textured coating layer(s) may be formulated by the manufacturer to include any of the above-mentioned additives, such as an UV stabilizer. For example, the above-described aliphatic polyurethanes commercially available from Pacific Polymers International, Inc. (Garden Grove, Calif.) under the trade designation ELASTO-GLAZE are typically formulated with an UV stabilizer incorporated therein.

b. Interior Non-Textured Surface Materials

Interior non-textured coating layers used to form building panels of the present invention may comprise a variety of materials. Suitable materials include, but are not limited to, one or more polymeric materials, and one or more additives. In one exemplary embodiment of the present invention, the interior non-textured coating layer comprises an aromatic polyurethane in an amount of up to about 100 parts by weight (pbw), based on a total weight of the interior non-textured coating layer.

Commercially available aromatic polyurethanes that may be used in the present invention include, but are not limited to, aromatic polyurethanes described above such as the aromatic polyurethanes commercially available from Madison Chemical Industries, Inc. (Milton, Ontario CANADA) under the trade designation CORROCOTE.

The interior non-textured coating layer may further comprise one or more filler materials including, but not limited to, sand, hollow glass or polymeric microspheres, or a combination thereof. When present, each of the one or more filler materials typically comprises up to about 5.0 pbw, more typically, about 0.5 to about 1.5 pbw, based on a total weight of the interior non-textured coating layer.

Commercially available filler materials, such as those described above, are commercially available from a number of sources.

c. Foam Core Materials

Foam core layers used to form building panels of the present invention may comprise a variety of materials. Suitable materials include, but are not limited to, one or more polymeric materials, one or more foaming agents, and one or more additives. In one exemplary embodiment of the present invention, the foam core layer comprises a polyurethane in an amount of up to about 100 parts by weight (pbw), based on a total weight of the foam core layer.

Commercially available polyurethanes that may be used to form the foam core layer include, but are not limited to, polyurethanes commercially available from POLYTEK Development Corporation (Easton, Pa.) under the trade designation PolyFoam™, such as PolyFoam™ R-5, PolyFoam™ R-8, and PolyFoam™ F-5, each of which comprises a two-part liquid composition, which when mixed together, forms a self-skinning foam.

The foam core layer may further comprise one or more filler materials such as hollow glass and/or polymeric spheres. When present, each of the one or more filler materials typically comprises up to about 5.0 parts by weight (pbw), more typically, about 0.5 to about 1.5 pbw, based on a total weight of the foam core layer.

Commercially available filler materials, such as those described above, are commercially available from a number of sources.

The foam core layer desirably comprises a combination of materials to provide a foam core layer having a foam core layer density of up to about 20 pounds per cubic foot (pcf), more desirably, ranging from about 8 pcf to about 16 pcf, and even more desirably, ranging from about 8 pcf to about 14 pcf.

B. Column Base Profiles

Another building product of the present invention comprises a structural base profile.

1. Column Base Profile Construction

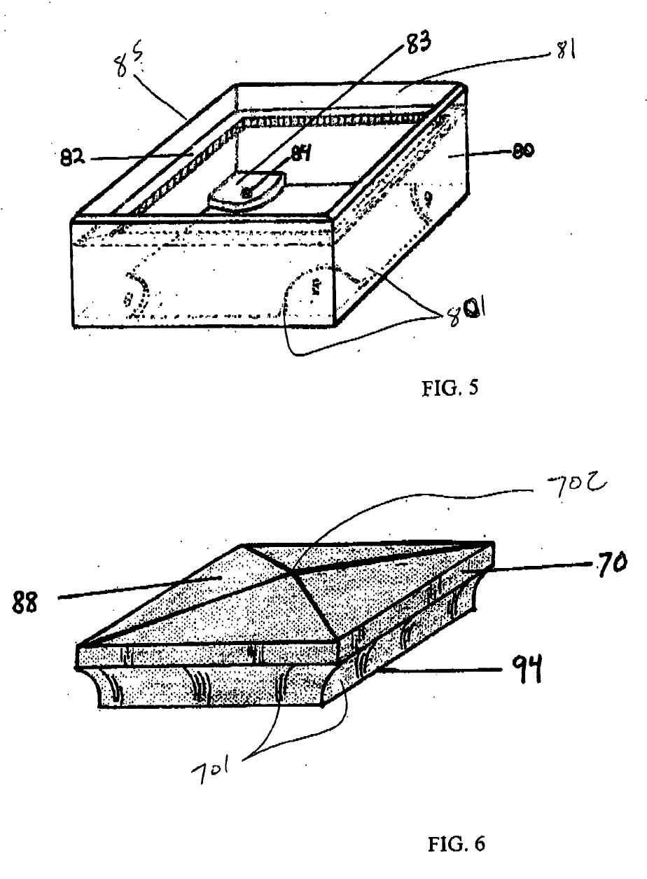

As shown in FIG. 5, exemplary structural base profile 80 comprises multiple sides 801 attached to one another. Although exemplary structural base profile 80 comprises four sides 801, it should be noted that the structural base profiles of the present invention may comprise less than four or more than four sides. In other words, structural base profiles of the present invention may have a variety of cross-sectional configurations including, but not limited to, square, rectangular, triangular, pentagonal, hexagonal, octagonal, etc.

Exemplary structural base profile 80 further comprises shelf 82 extending along an upper periphery of the multiple sides. Shelf 82 may be used to support a column structure (i.e., a column structure formed from one or more of the above-described building panels) partially inserted within an upper portion 81 of exemplary structural base profile 80. Typically, shelf 82 is positioned about 1 to 4 inches below an upper edge 85 of exemplary structural base profile 80.

Exemplary structural base profile 80 also comprises multiple mounting platforms 83 having mounting holes 84 positioned therein. Typically, exemplary structural base profile 80 has one mounting platform 83 and corresponding mounting hole 84 for each side used to form exemplary structural base profile 80. Mounting platform 83 and corresponding mounting hole 84 may be used to attach exemplary structural base profile 80 to a surface such as a building footer.

Structural base profiles of the present invention may have any desired dimensions. Typically, structural base profiles of the present invention have one or more sides, wherein each side has a length of less than about 2.0 feet.

2. Structural Base Profile Materials

The structural base profiles of the present invention may be formed from a variety of materials. Suitable materials include, but are not limited to, cement, marble dust, thermosettable polymers, one or more curing agents, fiber reinforcement such as fiberglass, one or more inorganic particles, one or more colorants, one or more additives (e.g., UV stabilizers, insecticides, etc.), or a combination thereof. In one exemplary embodiment of the present invention, the structural base profile comprises marble dust in an amount of up to about 90 parts by weight (pbw); a thermosettable polymer, such as an unsaturated polyester, in an amount of up to about 30 pbw; one or more curing agents in an amount of up to about 3 pbw; and one or more optional colorants in an amount of up to about 3 pbw; wherein all parts by weight are based on a total weight of the structural base profile.

In one desired embodiment of the present invention, the structural base profile comprises marble dust in an amount ranging from about 70 to about 90 pbw; unsaturated polyester in an amount ranging from about 30 to about 10 pbw; a curing agent comprising methyl ethyl ketone peroxide (MEKP) in an amount of up to about 3 pbw; and an optional colorant in an amount of up to about 3 pbw; wherein all parts by weight are based on a total weight of the structural base profile. In a further desired embodiment of the present invention, the structural base profile comprises marble dust in an amount of about 80 pbw; unsaturated polyester in an amount of about 20 pbw; a curing agent comprising methyl ethyl ketone peroxide in an amount of up to about 1 pbw; and an optional colorant in an amount of up to about 1 pbw; wherein all parts by weight are based on a total weight of the structural base profile.

Commercially available marble dust that may be used in the present invention include, but are not limited to, marble dust commercially available from Imerys Pigments and Additives Group (Roswell, Ga.) under the trade designation MARBLEMITE™.

Commercially available unsaturated polyester that may be used in the present invention include, but are not limited to, unsaturated polyesters commercially available from Reichhold, Inc. (Research Triangle Park, N.C.) under the trade designation POLYLITE® such as POLYLITE® 32153-00 (i.e., a solution of 2,5-furandione polymer with 1,3-isobenzofurandione, 2,2′-oxibis[ethanol], and 1,2-propanediol in styrene).

Commercially available curing agents are available form a number of sources. Commercially available curing agents that may be used in the present invention include, but are not limited to, methyl ethyl ketone peroxide (MEKP) commercially available from The Norac Company, Inc. (Azusa, Calif.) under the trade designation NOROX MEKP-925.

The structural base profile may further comprise one or more colorants. When present, the one or more colorants typically comprise up to about 5.0 parts by weight (pbw), more typically, about 0.5 to about 1.5 pbw, based on a total weight of the structural base profile.

Commercially available colorants that may be used in the present invention include, but are not limited to, the above-described colorants commercially available from BroCom Corporation (Colorado Springs, Colo.).

C. Structural Capital Profiles

A further building product of the present invention comprises a structural capital profile.

1. Column Base Profile Construction

As shown in FIG. 6, exemplary structural capital profile 70 comprises multiple sides 701 attached to one another. Although exemplary structural capital profile 70 comprises four sides 701, it should be noted that the structural capital profiles of the present invention may comprise less than four or more than four sides. Like the above-described structural base profiles, structural capital profiles of the present invention may have a variety of cross-sectional configurations including, but not limited to, square, rectangular, triangular, pentagonal, hexagonal, octagonal, etc.

Exemplary structural capital profile 70 further comprises upper surface 88 extending from each wall 701 to a location within a central point 702 along upper surface 88. Further, exemplary structural capital profile 70 comprises a lower periphery 94. Lower periphery 94 may be shaped to at least partially fit over a column structure (i.e., a column structure formed from one or more of the above-described building panels).

Structural capital profiles of the present invention may have any desired dimensions. Typically, structural capital profiles of the present invention have one or more sides, wherein each side has a length of less than about 2.0 feet.

2. Structural Capital Profile Materials

The structural capital profiles of the present invention may be formed from a variety of materials. Suitable materials include, but are not limited to, any of the above-described materials used to form building panels of the present invention. In one exemplary embodiment of the present invention, the structural capital profile comprises (i) an exterior coating layer comprising one or more of the above-described materials used to form the above-described exterior textured coating layer of a building panel (e.g., an aliphatic polyurethane with one or more additives), (ii) a foam core layer comprising one or more of the above-described materials used to form the above-described foam core layer of a building panel (e.g., a polyurethane with one or more additives), and (iii) an interior coating layer comprises one or more of the above-described materials used to form the above-described interior non-textured coating layer of a building panel (e.g., an aromatic polyurethane with one or more additives).

In one desired embodiment of the present invention, the structural capital profile comprises (i) an exterior coating layer comprising an aliphatic polyurethane with one or more of the following optional additives: UV stabilizers, insecticides, and colorants; (ii) a foam core layer comprising a polyurethane with one or more of the following optional additives: hollow glass or polymeric spheres, sand, or colorants; and (iii) an interior coating layer comprises an aromatic polyurethane with one or more of the following optional additives: hollow glass or polymeric spheres, sand, or colorants.

Commercially available marble dust that may be used in the present invention include, but are not limited to, the above-described marble dusts commercially available from Imerys Pigments and Additives Group (Roswell, Ga.). Commercially available unsaturated polyesters. that may be used in the present invention include, but are not limited to, the above-described unsaturated polyesters commercially available from Reichhold, Inc. (Research Triangle Park, N.C.).

The structural capital profile may further comprise one or more colorants. When present, the one or more colorants typically comprise up to about 5.0 parts by weight (pbw), more typically, about 0.5 to about 1.5 pbw, based on a total weight of the structural base profile. Commercially available colorants that may be used in the present invention include, but are not limited to, the above-described colorants commercially available from BroCom Corporation (Colorado Springs, Colo.).

II. Methods of Making Building Products

The present invention is further directed to methods of making the above-described building products. The various method steps in the methods of the present invention may be practiced manually as individual steps or in combination with one another in an assembly line process. A number of method steps may also be automated to produce a number of the above-described building products in an efficient, timely manner.

A. Methods of Making Building Panels

In one exemplary method of the present invention, the method comprises a method of making a building panel comprising the steps of (a) placing an insert into a mold, wherein the insert has an outer surface profile comprising (i) multiple areas, each of which has an appearance, size and shape resembling a man-made tile, a man-made brick or a natural stone, and (ii) a grid of grout ridges surrounding at least a portion of each of the multiple areas, (b) applying a first coating onto the insert, (c) applying a second coating onto a mold lid, wherein the mold lid has a size and shape so as to fit onto an upper periphery of the mold, forming an enclosed volume within the mold, (d) fixing the mold lid onto the mold, (e) injecting a foamable core material into the enclosed volume within the mold, and (f) curing the first coating, the second coating and the foamable core material to form a building panel having an exterior surface profile that is a mirror image of the outer surface profile of the insert.

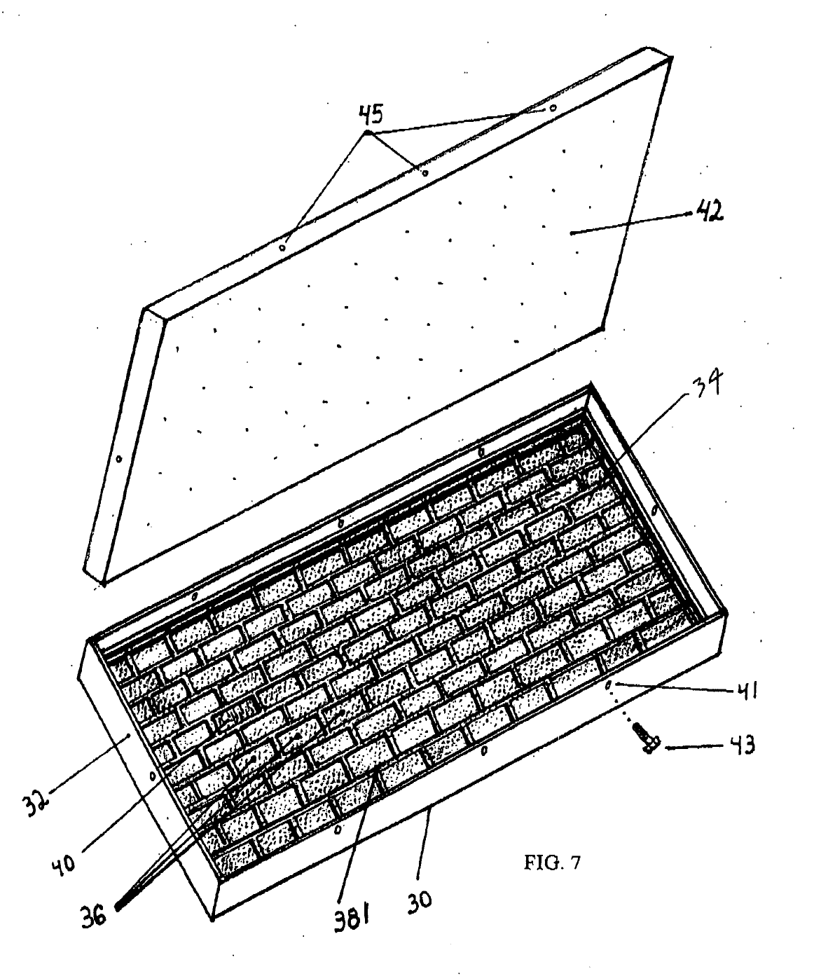

The methods of the present invention may be better understood by referencing the apparatus shown in the accompanying figures. An exemplary mold box suitable for use in the present invention is shown in FIG. 7. Exemplary mold box 30 comprises a lower side (not shown), side walls 32 extending upward from the lower side, and lid 42. Lid 42 fits snugly along an upper periphery of side walls 32 to form a volume within mold box 30. The height of the side walls 32 may vary to provide a desired overall thickness of a finished building panel. As shown in FIG. 7, form liner 34 rests along an interior lower surface of mold box 30. Form liner 34 may be selected from an inventory of form liners, wherein each form liner provides a unique pattern of multiple areas and grout lines as shown in the exemplary building panels of FIGS. 1-2. In this exemplary embodiment, form liner 34 is a mirror image of the pattern within exterior textured coating layer 50 of exemplary building panel 20 shown in FIG. 2.

An inventory of form liners may be prepared using a variety of materials. Suitable form liners for use in the present invention may include, but are not limited to, form liners formed from urethane molding rubber materials commercially available from Industrial Polymers Incorporated (Houston, Tex.) under the trade designations TRUECAST™, such as TRUECAST™ GTS-00, GTS-10, GTS-20, GTS-30, GTS-40, GTS-50, GTS-55, GTS-55 Slow, GTS-360, NBP-836, GTS-65, GTS-65 Slow, GTS-70, GTS-85F, and GTS-90.

As illustrated in FIG. 7, form liner 34 is fitted into the bottom mold box 30 extending upward along side walls 32 if desired. Exemplary form liner 34 has a plurality of repeating recess cavities 36, which vary in upper surface texture 40 and provide a simulated brick wall appearance. Grout ridges 381 form ridges between recess cavities 36, and simulate grout lines between bricks. Because of the flexibility and strength of form liner 34, form liner 34 can be used over and over to form numerous building panels.

Once form liner 34 is fitted into mold box 30, an optional release coating may be applied onto form liner 34. Any conventional release coating may be used in the present invention including, but not limited to, silicone-containing release coating materials, polyolefin release coating materials, and halogenated hydrocarbon release coating materials. Suitable commercially available release coating materials include, but are not limited to, release coatings commercially available from POLYTEK® Development Corporation (Easton, Pa.) under the trade designation POL-EASE, such as POL-EASE 2300 Mold Release, a halogenated hydrocarbon/ether blend; and release coatings commercially available from Cresset Chemical Company (Weston, Ohio) under the trade designation CRETE-LEASE, an aerosol silicone-containing release coating material.

In some cases, form liner 34 already possesses release properties so applying a release coating is unnecessary. Examples of such form liners include, but are not limited to, form liners formed from silicone rubbers commercially available from POLYTEK® Development Corporation (Easton, Pa.) under the trade designation PLATSIL®, such as the PLATSIL® 71 series of silicone rubbers. After applying a release coating, one or more colorant-containing layers or layer portions may be applied onto form liner 34. In one exemplary embodiment of the present invention, a masking layer is applied over grout ridges 381 to mask grout ridges 381. One or more colorant-containing layer portions are applied onto multiple areas surrounding by the mask, forming an outermost surface of the multiple areas (i.e., the areas resembling bricks, tiles or stones) located within the exterior textured layer coating. These layer portions are typically applied via a brushing, spraying or painting step, desirably a spraying step. The masking layer is then removed, and one or more additional colorant-containing layer portions are applied to form an outermost surface of the grout lines (i.e., the areas between the simulated bricks, tiles or stones) located within the exterior textured layer coating. These layer portions are typically applied via a brushing, spraying or painting step, desirably a painting step using a paint roller. Desirably, each of the above-described colorant-containing layer portions comprise aliphatic polyurethane and one or more colorants as discussed above.

Once the desired color scheme of the exterior textured layer coating is applied onto form liner 34, any additional layers may be applied to form a multi-layered exterior textured layer coating, a foamable core layer, an interior non-textured layer, or any combination thereof. In one exemplary embodiment, a foamable core layer material is applied over the above-described colorant-containing layer(s). Lid 42 is coated with an optional release coating using a release material as described above. An interior non-textured coating composition is then applied onto lid 42. Lid 42 is then positioned onto side walls 32, and attached to mold box using any conventional fastener, such as bolts 43 extending through holes 41 within side walls 32 and into holes 45 of lid 42. The foamable material within mold box 30 is allowed to expand, cure and harden. Typically, the foamable material expands, cures and hardens over a period of about two hours without the application of heat or pressure. Desirably, the foamable material is a moisture curable material. The resulting solid panel is then removed from form liner 34 and mold box 30.

In an alternative exemplary embodiment, once the foamable material is applied over the colorant-containing layer(s), and lid 42 is coated with an optional release coating, lid 42 is positioned onto side walls 32, and attached to mold box as described above. The foamable material within mold box 30 is allowed to at least partially harden. Lid 42 is removed, and an interior non-textured coating composition is applied onto the at least partially harden foam core. Lid 42 is then reapplied, and the foamable material is allowed to complete the hardening and/or curing process. The resulting solid panel is then removed from form liner 34 and mold box 30.

In any of the above-mentioned applying steps, a coating material may be applied using any known coating technique including, but not limited to, spray coating, solution coating, painting, transfer coating, etc. Desirably, coatings are applied using a spray coating step or a paint roller step. The foamable material for forming the foam core may be poured into mold box 30 as oppose to being spray coated. In a further embodiment, a foamable core material in the form of a two-component formulation (e.g., components A and B) can be mixed in a foam machine and injected into mold box 30 and subjected to heat in order to thermally bonded the exterior textured coating layer and interior non-textured coating layer to the foam core. In yet a further embodiment, a foam core material (i.e., already in the form of a foam) can be placed within mold box 30 and subjected to heat and/or pressure in order to thermally and/or mechanically bond the exterior textured coating layer and interior non-textured coating layer to the foam core.

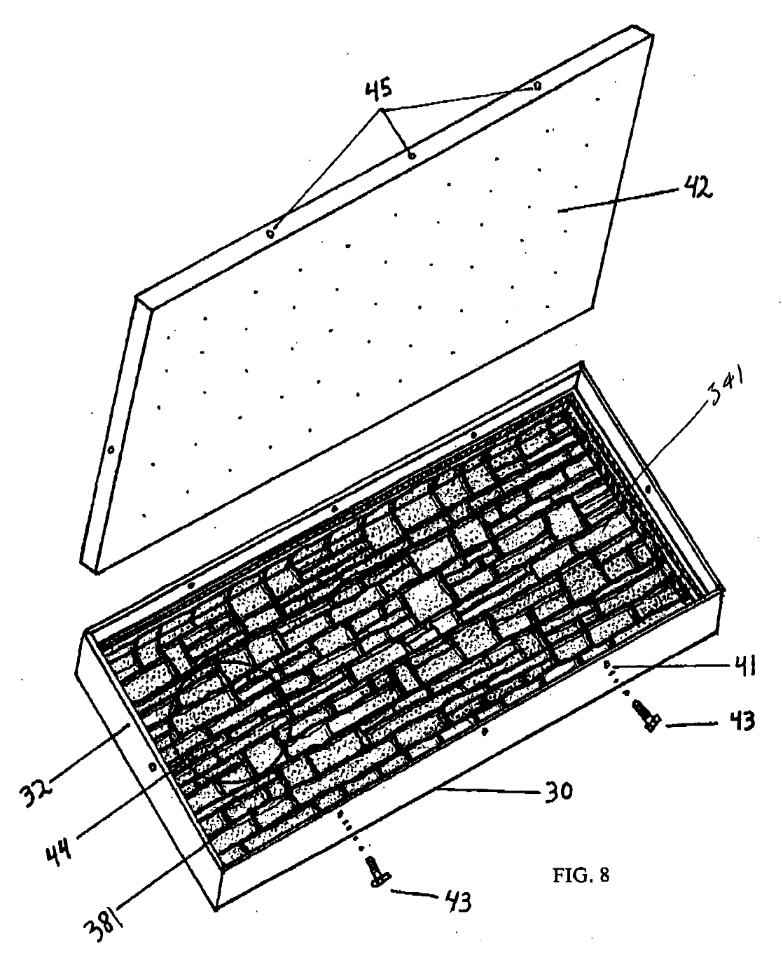

FIG. 8 shows exemplary mold box 30 having upwardly extended side walls 32, and a different form liner, form liner 341. In this embodiment, exemplary form liner 341 comprises an irregular stone pattern of stone cavities 44 having grout ridges 381 therebetween. Like exemplary form liner 34, exemplary form liner 341 fits into the bottom and extends upwardly along side walls 32 of mold box 30. Exemplary form liner 341 has a plurality of cavities 44 having different shapes and sizes, which replicate natural stone. Each irregular cavity 44 has been cut and formed to represent a precise location, shape, and size in the overall form liner. Such precision of the location, shape, and size of cavities 44 in the overall form liner results in building panels having irregularly shaped and sized multiple areas in precise locations along a building panel.

After curing and removal from a mold box, the building panel may be cut to form building panels having desired dimensions. As discussed above with reference to FIGS. 1A-1B, an exemplary panel 10 may be cut by an operator along at least six non-interrupted horizontal lines (i.e., lines 106A to 106F) and at least sixteen non-interrupted vertical lines (i.e., lines 108A to 108P). Further, an operator may also cut exemplary panel 10 along key cut lines 112 and 110 to form panels that interlock with one another as shown in FIG. 3. Any key pattern may be used in exemplary panel 10 as long as multiple panels can be positioned and combined with one another so that the resulting combination of building panels forms a continuous pattern of simulated bricks, tiles or stones.

In a further embodiment of the present invention, one-piece corner panels may be prepared using corner mold boxes as shown in FIGS. 9-10. As shown in FIG. 9, outside corner mold box 52 comprises lower section 521 having upwardly extended side walls 32, wherein the height of side walls 32 is chosen to provide a desired thickness for the finished outside corner panel. Form liner 342 is again selected from an inventory of various form liners to provide a desired simulated brick, tile or stone pattern in the finished building panel. Form liner 342 is then fitted onto the inner surfaces of lower section 521 of mold box 52. In this exemplary embodiment, form liner 342 has a plurality of different cavities 44 having irregular shapes and sizes, which form a pattern having outer pattern edges that correlate to matching left and right end edges (i.e., key cut lines 112 and 110) of exemplary finished building panel 10 shown in FIG. 1A. Each cavity has been crafted and formed to represent a precise location, shape, and size in form liner 342 to allow a proper fit when the resulting outside corner panel is mated with building panels such as exemplary finished building panel 10 shown in FIG. 1A. The mated building panels provide the appearance of a continuous running wall of brick, tile or stone.

Outside corner building panels may be prepared as outlined above using exemplary outside corner mold box 52. A series of coating and/or masking steps may be used to form the exterior textured coating layer and the interior non-textured coating layer on exemplary form liner 342. The foam core may be formed using any of the techniques described above.

FIG. 10 provides an exemplary inside corner mold box 58 having similar features as described above for exemplary outside corner mold box 52 shown in FIG. 9. Like exemplary form liner 342 shown in FIG. 9, exemplary form liner 343 shown in FIG. 10 has a plurality of different cavities 44 having irregular shapes and sizes, which form a pattern having outer pattern edges that correlate to matching left and right end edges (i.e., key cut lines 112 and 110) of exemplary finished building panel 10 shown in FIG. 1A.

In FIGS. 9-10, solid black areas 56 represent void areas that do not contain an exterior texture coating material. Foamable material (or a foam core) is applied directly over solid black areas 56. Once cured, the resulting building panel comprises only (i) a foam layer and (ii) an interior non-textured coating layer in areas of the building panel corresponding to solid black areas 56.

In an alternative embodiment, solid black areas 56 extend upper a length substantially equal to the height of side walls 32. In this embodiment, interior non-textured coating is applied directly over solid black areas 56. Once cured, the resulting building panel comprises only (i) an interior non-textured coating layer in areas of the building panel corresponding to solid black areas 56.

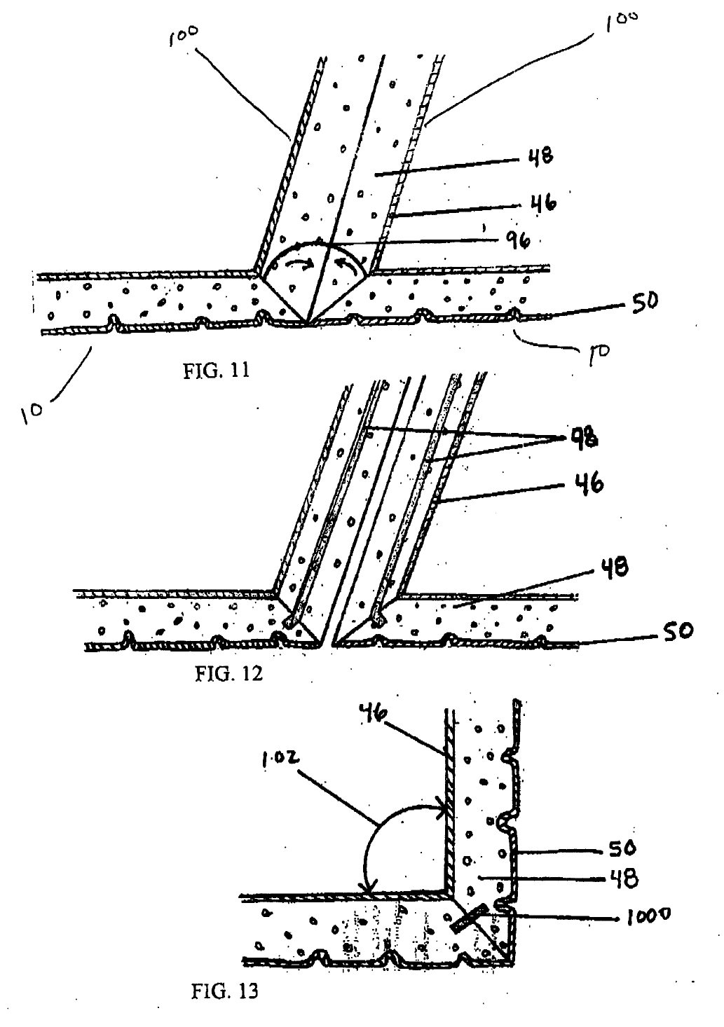

As discussed above in reference to FIG. 4, one or more building panels of the present invention may be attached to one another to form a building panel having an angle between the adjacent panels. One method of joining building panels to one another is shown in FIGS. 11-13. As shown in FIG. 11, exemplary finished building panels 10 may be cut along one or more edges 100 at a desired angle 96, such as, for example, a 45° angle, to form exposed areas of foam core 48 positioned between exterior textured coating layer 50 and interior non-textured coating layer 46. In the embodiment shown in FIGS. 11-13, exemplary finished building panels 10 are cut so as to form an outside corner building panel from exemplary finished building panels 10. As shown in FIG. 12, channels 98 are cut into exposed areas of foam core 48. As shown in FIG. 13, channel insert 1000 is positioned within a first channel 98, exemplary finished building panels 10 are positioned next to one another so that channel insert 1000 extends from channel 98 of the first exemplary finished building panel 10 into channel 98 of the second exemplary finished building panel 10. In addition to mechanical bonding via channel insert 1000, an adhesive may be used to further enhance the bond between adjacent building panels. Although a 90° angle is shown between adjacent building panels in FIG. 13, it should be noted that any angle may be used between adjacent building panels. Further, inside corner building panels may be prepared using a similar approach.

B. Methods of Making Structural Base Profiles

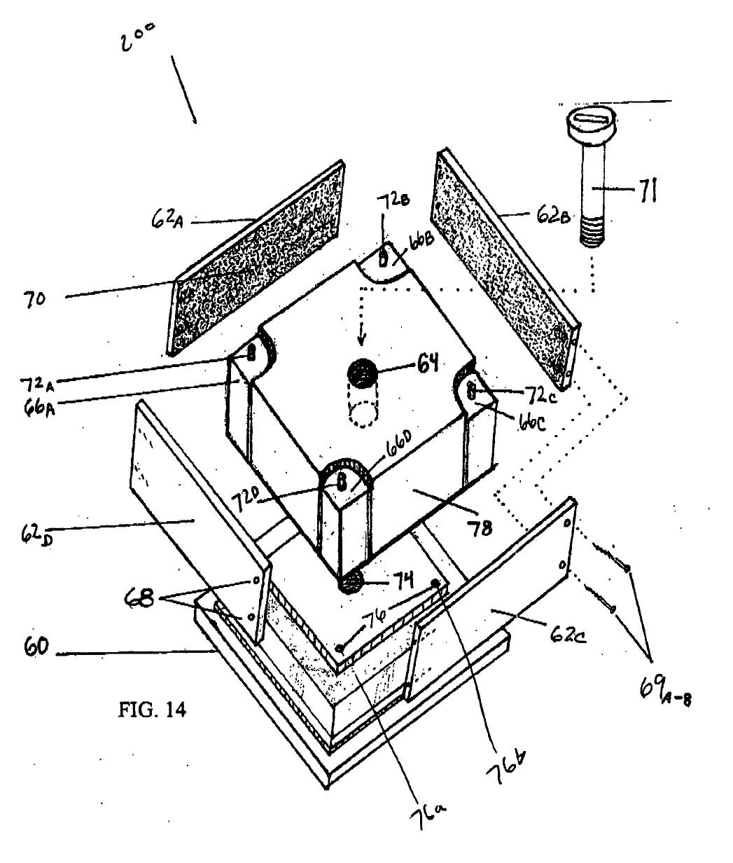

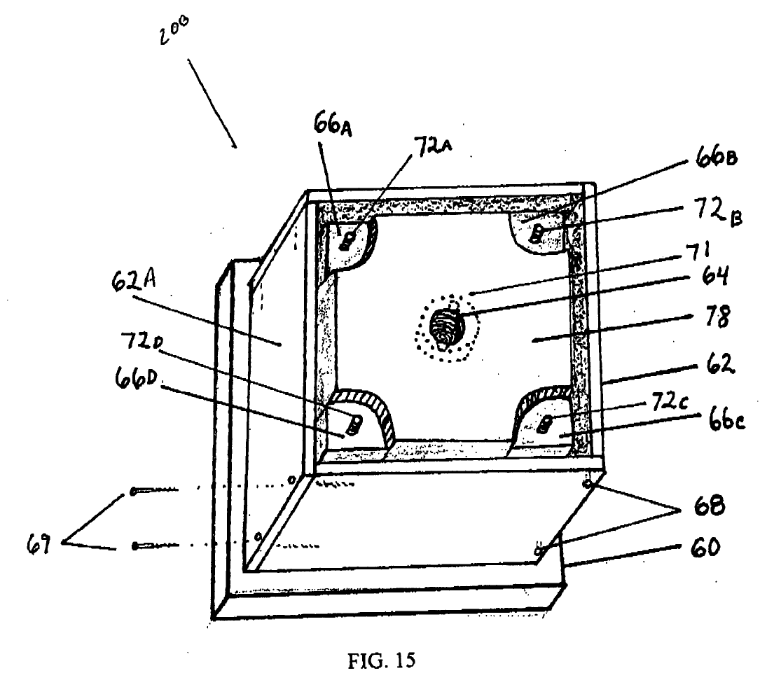

The present invention is further directed to methods of making structural base profiles as shown in FIG. 5. An exemplary mold for forming a structural base profile is shown in FIGS. 14-15. As shown in FIG. 14, exemplary mold 200 comprises base 60, plurality of side walls 62A to 62D for forming exterior textured side walls 801 of the resulting structural base profile (see FIG. 5), mandrel 78, and mandrel inserts 66A to 66D. Plurality of side walls 62A to 62D are attached to one another to form an outer perimeter of mold 200. Any suitable fasteners may be used to attach plurality of side walls 62A to 62D to one another including, but not limited to, screws 69 extending through holes 68 and into an adjacent side wall component. FIG. 15 shows mold 200 in assembled form.

Mandrel 78 comprises a main body having a number of side walls corresponding to the number of side walls used to form the outer perimeter of mold 200. In this exemplary embodiment, mandrel 78 comprises four side walls. Mandrel 78 is positioned within the outer perimeter of mold 200 formed by side walls 62A to 62D and is secured to base 60 by a center alignment shaft 71 inserted through hole 64 in mandrel 78 and into a corresponding hole 74 in base 60. The distance between outer surfaces of mandrel 78 and inner surfaces of side walls 62A to 62D is determined by the specifications for a particular structural base profile being molded or casted.

Once mandrel 78 is in place, mandrel inserts 66A to 66D are positioned in each corner of mandrel 78. Mandrel inserts 66A to 66D are secured in position by using alignment pins 72a to 72d that screw into base 60 of mold 200. During a de-molding process, inserts 66A to 66D are designed to break away from mandrel 78 by unscrewing alignment pins 72a to 72d. Plurality of side walls 62A to 62D have a textured surface 70 facing inside a mold cavity. During molding, the pattern of textured surface 70 is transferred to the outer surface of the resulting structural base profile.

Alignment pins 72a to 72d serve at least two purposes: first, to maintain proper positioning of mandrel inserts 66A to 66D and mandrel 78 during the molding or forming process, and secondly, to provide a void space in the structural base profile so as to allow the structural base profile to be mounted onto another structure (i.e., to form mounting platforms). As shown in FIG. 5, exemplary structural base profile 80 comprises multiple mounting platforms 83 having mounting holes 84 positioned therein. Each of the multiple mounting platforms 83 is formed using mandrel inserts 66A to 66D and mandrel 78 as described above.

Once mold 200 is assembled as shown in FIG. 15, a hardenable material (not shown) is poured into the mold cavity between outer surfaces of mandrel 78 and inner surfaces of side walls 62A to 62D. The hardenable material may fill the mold cavity up to an upper surface of mandrel 78 (but not covering the upper surface of mandrel 78) to form a structural base profile similar to exemplary structural base profile 80. Alternatively, hardenable material may fill the mold cavity up to and over an upper surface of mandrel 78 to form a structural base profile having a bottom layer thickness substantially equal to the thickness of the hardenable material layer covering the upper surface of mandrel 78, as well as thicker mounting platforms in each corner of the resulting structural base profile.

After mold 200 has been filled with a desired hardenable material, the hardenable material is allowed to harden to form a solid structure base profile, such as exemplary structural base profile 80 shown in FIG. 5. Mandrel alignment pins 72a to 72d are unscrewed and removed. The cured structural base profile and mold 200 are inverted and de-molded. To de-mold, screws 69 are removed, and side walls 62A to 62D are separated from base 60. Center alignment shaft 71 is unscrewed from center post hole 74 of base 60 to release mandrel 78 from base 60. The cured structural base profile is now separable from mandrel 78 and mandrel inserts 66A to 66D. Mandrel inserts 66A to 66D typically separate from and fall out of the cured structural base profile by turning the structural base profile upside down. In order to further decrease adhesion between (i) mandrel 78 and mandrel inserts 66A to 66D and (ii) the resulting structural base profile, a release coating may be applied to mandrel 78 and mandrel inserts 66A to 66D prior to pouring the hardenable material into the mold cavity.

The resulting structural base profile may be used as is or may be stored for later use. The process is may be repeated using mold 200 again.

In one exemplary embodiment of the present invention, a structural base profile is formed using the following method steps: assembling a mold such as shown in FIG. 15, applying a release coating to an inner surface of the mold or alternatively positioning a form liner having released properties into the mold, mixing one or more components to form a hardenable material mixture, allowing the hardenable material mixture within the mold to harden, and disassembling the mold. Desirably, the hardenable material mixture comprises marble dust; a thermosettable polymer resin, such as a polyester resin; a curing agent, such as a peroxide; and an optional colorant.

It should be understood that mold 200 may vary in the component dimensions depending on the size of the structural base profile being made. Molds having dimensions up to about 6 feet may be used to prepare structural base profiles having at least one side dimension of up to about 6 feet. Typically, the molds and the resulting structural base profiles have dimensions of about 12, 16, 20, 24, or 36 inches.

C. Methods of Making Structural Capital Profiles

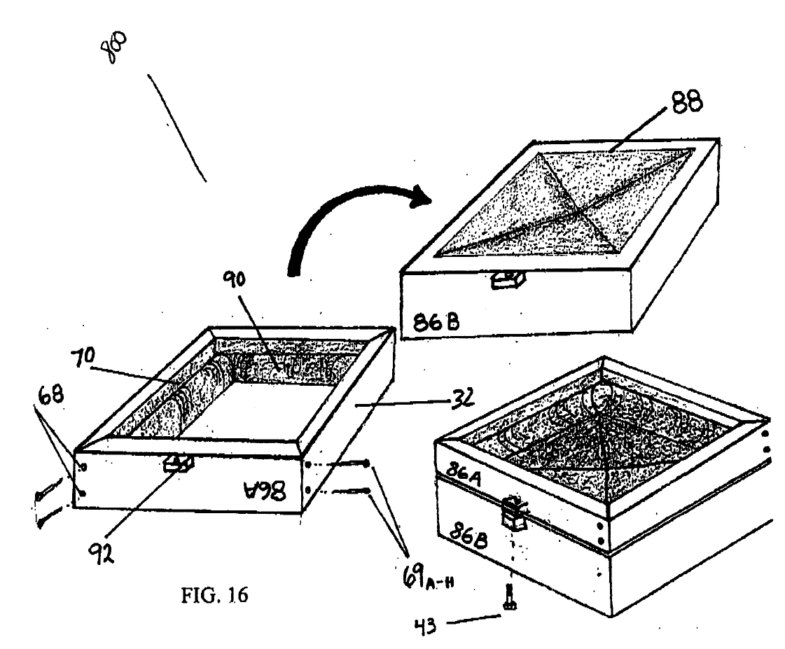

The present invention is even further directed to methods of making structural capital profiles as shown in FIG. 6. An exemplary two-component mold for forming a structural base profile is shown in FIG. 16. As shown in FIG. 6, two-component mold 800 comprising mold section 86a and mold section 86b suitable for forming a structural capital profile. Mold section 86a has four sides 32 attached to one another using fasteners, in this case, screws 69 inserted through holes 68 and into an adjacent side. After mold section 86a is assembled, mold section 86a is stacked on top of mold section 86b as shown in FIG. 16.

On at least one outer surface of mold sections 86a and 86b are corresponding mold box brackets 92, which secure mold sections 86a and 86b together with bolt 43. An appropriate capital-forming mixture is selected and applied to the inside of mold 800. The mixture is allowed to cure and the mold is disassembled by separating mold sections 86a and 86b from one another, and removing screws 69 to separate sides 32 from one another. The cured structural capital profile may be used as is or stored for future use.

In one exemplary embodiment of the present invention, a structural capital profile is formed using the following method steps: assembling a two-component mold such as shown in FIG. 16, applying a release coating to an inner surface of the two-component mold or alternatively positioning a form liner having released properties into the two-component mold, applying an exterior coating layer onto the release coating or form liner, applying a foamable core layer onto the exterior coating layer, applying an interior coating layer onto the foamable core layer, allowing the materials within the mold to harden, and disassembling the two-component mold. Desirably, the exterior coating layer comprises one or more of the above-described materials used to form the above-described exterior textured coating layer (e.g., an aliphatic polyurethane with one or more additives), the foamable core layer comprises one or more of the above-described materials used to form the above-described foam core layer (e.g., a polyurethane with one or more additives), and the interior coating layer comprises one or more of the above-described materials used to form the above-described interior non-textured coating layer (e.g., an aromatic polyurethane with one or more additives).

It should be understood that two-component mold 800 may vary in the component dimensions depending on the size of the structural capital profile being made. Two-component molds having dimensions of up to about 6 feet may be used to prepare structural capital profiles having at least one side dimension of up to about 6 feet. Typically, the molds and the resulting structural base profiles have dimensions of about 12, 16, 20, 24, or 36 inches.

III. Methods of Using Building Products

The present invention is further directed to methods of using the above-described building products to prepare various structural components. The resulting structural components have superior weather, sun and water resistance. In one exemplary embodiment of the present invention, the above-described building products are assembled to make a column. For example, one or more of the above-described building panels may be combined to form a column section, which is partially inserted and connected to a structural base profile having similar dimensions. The structural base profile can be mounted to a foundation or footer allowing the column section to be secured to the stationary base profile. A structural capital profile may then be attached to an upper portion of the column section formed by one or more of the above-described building panels.

Such column structures formed from the above-described building components of the present invention are resistant to weather, as well as abrasion from such sources as lawnmowers or weed trimmers. The column structure may comprise multiple column sections (i.e., each section being formed from one or more of the above-described building panels) stacked atop one another until a desired height is achieved. When two or more sections are stacked together, it is desirable for an internal support, such as metal reinforcement, to be used to support the structure.

The present invention provides a lightweight capital structure that can be secured over the uppermost section of the column structure to provide a weather shield and a decorative top. The above-described building panels can be assembled into a variety of structure configurations, for example, 12″, 16″, 20″, 24″, 32″, 36″, 42″ and 48″ square column structures, as well as 12″×16″, 16″×24″, 20″×24″, and 24″×36″ rectangular column structures with interlocking matching edges having aligned grout and/or joint lines.

In addition to forming column structures, the building panels of the present invention may be used to form a variety of articles including, but not limited to, fencing components such as posts, columns and entry gates; landscaping components such as accent structures, arbor bases, plant stands, lighted posts, waterfall structures, fountain components, and bird baths; gardening components such as pots and planters; outdoor furniture components such as chairs, lounge chairs, tables and table tops, and storage containers; signage components such as commercial signs and sign structures, advertising structures, and development entrance signage; display components such as displays for tradeshows and custom manufactured displays; equestrian components such as props and jump stations; manufactured housing components such as exterior walls, interior accent walls, and foundation skirting; construction components such as new construction and retrofit application, fireplace structures, mailbox structures, interior or exterior wall structure for a new or existing building, various tubular structures having interlocking matching edges with aligned grout and/or joint lines, and chimney boxes.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLE 1

### Preparation of Building Panel

An exemplary building panel was formed using the following procedure. A two-part mold such as shown in FIG. 7 was used. The mold had the following outer dimensions: length—4 feet, width—8 feet, and height—4 inches. A form liner having release properties (i.e., a silicone rubber form liner formed from PLATSIL® 71, commercially available from POLYTEK® Development Corporation (Easton, Pa.)) was positioned within the mold box. A mask layer was applied over the grout ridges of the form liner. Three separate exterior coating layer portions were sprayed onto different multiple areas of the form liner. Each exterior coating layer portion comprised ELASTO-GLAZE 6001 AL aliphatic polyurethane (commercially available from Pacific Polymers International, Inc. (Garden Grove, Calif.)) having various grey/brown coloring to simulate the color of stone. After applying the exterior coating layer portions, the making layer was removed.

An additional exterior coating layer portion was applied onto the grout ridges of the form liner using a paint roller. This exterior coating layer portion comprised ELASTO-GLAZE 6001 AL aliphatic polyurethane (commercially available from Pacific Polymers International, Inc. (Garden Grove, Calif.)) having an off-white/grey coloring to simulate the color of grout.

An interior coating layer (CORROCOTE PLUS commercially available from Madison Chemical Industries, Inc. (Milton, Ontario CANADA)) was sprayed onto the lid of the mold. The lid was attached to the mold box portion of the mold.

A foamable core layer mixture was formed by mixing the two components (e.g., components A and B) of PolyFoam™ R-5, a polyurethane commercially available from POLYTEK Development Corporation (Easton, Pa.). Immediately after mixing, the foamable polyurethane mixture was injected into a cavity within the mold between the exterior coating layer and the interior coating layer. The mold contents were allowed to harden for a period of 24 hours. The mold lid was then removed, and the resulting building panel was separated from the mold box and form liner.

The resulting building panel had an exterior coating layer with an average layer thickness of about 0.5 mm (25 mil), a foam core layer with a maximum layer thickness of about 12.7 mm (500 mil), and an interior coating layer with an average layer thickness of about 2.5 mm (100 mil).

### EXAMPLE 2

### Preparation of Structural Base Profile

An exemplary structural base profile was formed using the following procedure. A mold such as shown in FIG. 15 was assembled. The two-component mold had the following outer dimensions: length—12 inches, width—12 inches, and height—8 inches. A release coating (CRETE-LEASE, commercially available from Cresset Chemical Company (Weston, Ohio)) was sprayed onto an inner surface of the mold.

A hardenable mixture was formed by mixing the following components:

| Component Name | Component Type | Amount | |
|---|---|---|---|
| MARBLEMITE ™ | marble dust | 100 | lbs. |
| POLYLITE ® 32153-00 | polyester resin | 25 | lbs. |
| NOROX MEKP-925 | MEKP curing agent | 2.5 | oz. |
| titanium dioxide | Off-white pigment | 2.5 | oz. |

The hardenable mixture was poured into the mold, and allowed to harden for about 24 hours. The mold was disassembled, and the resulting structural base profile was removed from the mold.

The resulting structural base profile had an exterior coating layer with an average layer thickness of about 1.4 mm (55 mil), a foam core layer with a maximum layer thickness of about 5 inches, and an interior coating layer with an average layer thickness of about 2.5 mm (100 mil).

### EXAMPLE 3

### Preparation of Structural Capital Profile

An exemplary structural capital profile was formed using the following procedure. A two-component mold such as shown in FIG. 16 was assembled. The two-component mold had the following outer dimensions: length—13 inches, width—13 inches, and height—6.5 inches. A release coating (CRETE-LEASE, commercially available from Cresset Chemical Company (Weston, Ohio)) was sprayed onto an inner surface of the two-component mold. An exterior coating layer (ELASTO-GLAZE 6001 AL having a white color, commercially available from Pacific Polymers International, Inc. (Garden Grove, Calif.)) was sprayed onto the release coating.

A foamable core layer mixture was formed by mixing the two components (e.g., components A and B) of PolyFoam™ R-5, a polyurethane commercially available from POLYTEK Development Corporation (Easton, Pa.). Immediately after mixing, the foamable polyurethane mixture was poured into the mold over the exterior coating layer. The foamable polyurethane mixture was allowed to partially harden for a period of two hours. Then, an interior coating layer (CORROCOTE PLUS commercially available from Madison Chemical Industries, Inc. (Milton, Ontario CANADA)) was sprayed onto the partially hardened foam core layer. The mold contents were allowed to further harden for a period of 24 hours. The two-component mold was then disassembled, and the resulting structural capital profile was removed.

The resulting structural capital profile had an overall width of about 12 inches, an overall length of about 12 inches, an overall height of about 6 inches, and an average wall thickness of about 1.0 inch.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

1. A building panel comprising:
a foam core having a first outer surface and a second outer surface;
a first coating on the first outer surface of the foam core, said first coating having an outer surface profile comprising:
multiple areas, each of which has an appearance, size and shape resembling a man-made tile, a man-made brick or a natural stone, and
a grid of grout lines surrounding at least a portion of each of the multiple areas; and
a second coating on the second outer surface of the foam core, said second coating having a substantially flat surface profile.

2. The building panel of claim 1, further comprising:
an edge region along at least a portion of an outer periphery of the building panel, said edge region (i) having an overall thickness of less than an overall thickness of the building panel, (ii) having an edge area with a width and a length, said length being up to a full length of the building panel, and (iii) comprising one or more holes positioned through the edge region, said holes suitable for containing a nail or screw used to attach the building panel to a construction surface.

3. The building panel of claim 1, wherein the building panel comprising four sides, and the edge region is positioned along two of the four sides of the building panel.

4. The building panel of claim 1, wherein each of the multiple areas has substantially the same appearance, size and shape.

5. The building panel of claim 1, wherein the multiple areas have a variety of sizes and shapes.

6. The building panel of claim 1, wherein the first coating comprises an aliphatic polyurethane, and the second coating comprises an aromatic polyurethane.

7. The building panel of claim 6, wherein the foam core comprises a polyurethane foam.

8. The building panel of claim 2, wherein the edge region comprises an aromatic polyurethane and is contiguous with the second coating.

9. The building panel of claim 1, further comprising a 45° edge along at least one side of the building panel.

10. A construction panel comprising two building panels, wherein each building panel comprises the building panel of claim 9, said building panels attached to one another along respective 45° edges to form a construction panel having adjacent panels that are perpendicular to the other.

11. A structure comprising an outer structure surface, and one or more building panels attached to the outer structure surface, wherein at least one of the one or more building panels comprises the building panel of claim 1.

12. A column structure comprising two or more building panels attached to one another, wherein at least one of the two or more building panels comprises the building panel of claim 1.

13. The column structure of claim 12, wherein each building panel comprises the building panel of claim 1.

14. The column structure of claim 13, further comprising a base profile and a capital, wherein the two or more building panels attached to one another are further attached to the base profile and are positioned on top of the base profile; and the capital is attached to an upper surface of the two or more building panels attached to one another.

15. A building panel comprising:
a polyurethane foam core having a first outer surface and a second outer surface;
a first coating layer of aliphatic polyurethane on the first outer surface of the foam core, said first coating having an outer surface profile comprising:
multiple areas, each of which has an appearance, size and shape resembling a man-made tile, a man-made brick or a natural stone, and
a grid of grout lines surrounding at least a portion of each of the multiple areas; and
a second coating layer of aromatic polyurethane on the second outer surface of the foam core, said second coating having a substantially flat surface profile.

16. The building panel of claim 15, further comprising:
an edge region along at least a portion of an outer periphery of the building panel, said edge region (i) having an overall thickness substantially equal to the second coating layer and comprising an aromatic polyurethane, (ii) having an edge area with a width and a length, said length being up to a full length of the building panel, and (iii) comprising one or more holes positioned through the edge region, said holes suitable for containing a nail or screw used to attach the building panel to a construction surface.

17. The building panel of claim 15, further comprising a 45° edge along at least one side of the building panel.

18. A construction panel comprising two building panels, wherein each building panel comprises the building panel of claim 17, said building panels attached to one another along respective 45° edges to form a construction panel having adjacent panels that are perpendicular to the other.

19. A method of making a building panel, said method comprising the steps of:
placing an insert into a mold, said insert having an outer surface profile comprising:
multiple areas, each of which has an appearance, size and shape resembling a man-made tile, a man-made brick or a natural stone, and
a grid of grout ridges surrounding at least a portion of each of the multiple areas;
applying a first coating onto the insert;
applying a second coating onto a mold lid, said mold lid having a size and shape so as to fit onto an upper periphery of the mold, forming an enclosed volume within the mold;
fixing the mold lid onto the mold;
injecting a foamable core material into the enclosed volume within the mold; and
curing the first coating, the second coating and the foamable core material to form a building panel having an exterior surface profile that is a mirror image of the outer surface profile of the insert.

20. The method of claim 19, wherein the first coating comprises an aliphatic polyurethane, the second coating comprises an aromatic polyurethane, and the foamable core material comprises a polyurethane.
